(19) United States
(12) Patent Application Publication
(10) Pub. No.: US 2020/0088434 A1
(43) Pub. Date: Mar. 19, 2020

(54) WIRELESS SENSOR SYSTEM FOR HVAC SYSTEMS

(71) Applicant: Johnson Controls Technology Company, Auburn Hills, MI (US)

(72) Inventors: Joseph P. Diaz, Norman, OK (US); Theresa T. Dinh, Oklahoma City, OK (US); Curtis A. Trammell, Newcastle, OK (US); Vincent E. Ford, Norman, OK (US); Anthony J. Reardon, Moore, OK (US); Randall C. Forristall, Blanchard, OK (US); Tyler S. Riddle, Newcastle, OK (US); Robert C. Haddad, Oklahoma City, OK (US)

(21) Appl. No.: 16/143,725

(22) Filed: Sep. 27, 2018

Related U.S. Application Data
(60) Provisional application No. 62/733,502, filed on Sep. 19, 2018.

(51) Int. Cl. F24F 11/49; G05B 19/042; F24F 11/65; G08C 17/02; G05B 19/048

(52) U.S. Cl. CPC F24F 11/49; G05B 19/0421; F24F 11/65; F24F 2110/10; G05B 19/048; G05B 2219/2642; G08C 17/02

(57) ABSTRACT

A heating, ventilation, and/or air conditioning (HVAC) system. The system includes a housing with HVAC equipment. A sensor detects an operating condition of the HVAC system and wirelessly transmits a signal indicative of the operating condition. The sensor couples to or is disposed within the housing. A controller receives the signal indicative of the operating condition and controls operation of the HVAC system in response to the signal. The controller is coupled to or disposed within the housing.

### CROSS-REFERENCE TO RELATED APPLICATIONS

This application claims priority from and the benefit of U.S. Provisional Application Ser. No. 62/733,502, entitled “WIRELESS SENSOR SYSTEM FOR HVAC SYSTEMS”, filed Sep. 19, 2018, which is herein incorporated by reference in its entirety for all purposes.

### BACKGROUND

The present disclosure relates generally to communication in heating, ventilation, and air conditioning (HVAC) systems, and more particularly to a wireless sensor system for HVAC systems.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

Heat exchangers are used in HVAC systems to exchange energy between fluids. Typical, HVAC systems have two heat exchangers commonly referred to as an evaporator coil and a condenser coil. The evaporator coil and the condenser coil facilitate heat transfer between air surrounding the coils and a refrigerant that flows through the coils. For example, as air passes over the evaporator coil, the air cools as it loses energy to the refrigerant passing through the evaporator coil. In contrast, the condenser coil facilitates the discharge of heat from the refrigerant to the surrounding air. These HVAC systems typically include sensors that provide feedback to facilitate control of the HVAC system. These sensors communicate with and receive power from a controller through low-voltage wires, which may be referred to as a wiring harness. During the manufacture of the HVAC systems, the wiring harnesses may be improperly coupled to the sensors and/or wired incorrectly. The connection points between the sensors, wiring harness, and controller may also be susceptible to adverse environmental conditions, such as rain, which may affect operation of the HVAC system.

### SUMMARY

In one embodiment, a heating, ventilation, and/or air conditioning (HVAC) system. The system includes a housing with HVAC equipment. A sensor detects an operating condition of the HVAC system and wirelessly transmits a signal indicative of the operating condition. The sensor couples to or is disposed within the housing. A controller receives the signal indicative of the operating condition and controls operation of the HVAC system in response to the signal. The controller is coupled to or disposed within the housing.

In another embodiment, a heating, ventilation, and/or air conditioning (HVAC) system. The system includes a housing with HVAC equipment. A sensor system detects an operating condition of the HVAC system and wirelessly transmits a signal indicative of the operating condition. The sensor system is coupled to or disposed within the housing. The sensor system includes a sensor that detects the operating condition of the HVAC system. A power source powers the sensor and wireless transmission of the signal indicative of the operating condition.

In another embodiment, a heating, ventilation, and/or air conditioning (HVAC) system. The system includes a housing with HVAC equipment. The housing or the HVAC equipment includes a marking disposed thereon. A sensor detects an operating condition of the HVAC system and wirelessly transmits a signal indicative of the operating condition. The sensor is coupled to or disposed within the housing proximate the marking to facilitate desired operation of the sensor.

### BRIEF DESCRIPTION OF THE DRAWINGS

Various aspects of this disclosure may be better understood upon reading the following detailed description and upon reference to the drawings in which:

FIG. 1 is a perspective view of an embodiment of a building that may utilize a heating, ventilating, and/or air conditioning (HVAC) system in a commercial setting, in accordance with an aspect of the present disclosure;

FIG. 2 is a perspective view of a packaged HVAC unit, in accordance with an aspect of the present disclosure;

FIG. 3 is a perspective view of an embodiment of a residential split HVAC system, in accordance with an aspect of the present disclosure;

FIG. 4 is a schematic diagram of an embodiment of a vapor compression system that may be used in the packaged HVAC unit of FIG. 2 and the residential HVAC system of FIG. 3, in accordance with an aspect of the present disclosure;

FIG. 5 is a perspective view of an embodiment of a packaged HVAC unit having a sensor system, in accordance with an aspect of the present disclosure;

FIG. 6 is a schematic perspective view of an embodiment of a sensor system, in accordance with an aspect of the present disclosure;

FIG. 7 is a schematic side view of an embodiment of a sensor system coupling to an HVAC system, in accordance with an aspect of the present disclosure;

FIG. 8 is a schematic side view of an embodiment of a sensor system coupling to an HVAC system, in accordance with an aspect of the present disclosure;

FIG. 9 is a schematic side view of an embodiment of a sensor system coupling to an HVAC system, in accordance with an aspect of the present disclosure;

FIG. 10 is a schematic front view of an embodiment of a marking on an HVAC system, in accordance with an aspect of the present disclosure;

FIG. 11 is a schematic front view of an embodiment of a marking on an HVAC system, in accordance with an aspect of the present disclosure;

FIG. 12 is a schematic front view of an embodiment of a marking on an HVAC system, in accordance with an aspect of the present disclosure; and

FIG. 13 is a schematic front view of an embodiment of a marking on an HVAC system, in accordance with an aspect of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

An HVAC system includes heat exchangers, such as a condenser and an evaporator, that transfer thermal energy between a heat transfer fluid, such as a refrigerant, and a fluid to be conditioned, such as air. A compressor is used to circulate the refrigerant through conduits of the HVAC system, which fluidly couple the condenser, the evaporator, and the compressor. In some cases, the HVAC system may be configured to cool a flow of air by directing the flow of air across the evaporator of the HVAC system. A refrigerant flowing through the evaporator may absorb heat from the flow of air, and thus change phase within the evaporator. The refrigerant may exit the evaporator in a hot, gaseous state. In many cases, the condenser is used to remove the absorbed thermal energy from the refrigerant, such that the refrigerant may change phase before being recirculated through the conduits of the HVAC system. In order to control this cycle, the HVAC system includes multiple sensors that provide feedback regarding various operating conditions of the HVAC system. These conditions may include refrigerant and/or air temperature, refrigerant pressure, compressor speed, among others. A controller of the HVAC system uses feedback from the sensors to control operation of various components of the HVAC system. For example, the controller may control fans, compressors, and valves in response to detected operating conditions of the HVAC system.

Embodiments of the present disclosure are directed to an HVAC system with a wireless sensor system that enables wireless communication between sensors and the controller of the HVAC system. By using wireless communication, the HVAC system may be manufactured without low-voltage wires/low-voltage wiring harnesses that are typically used to provide power to the sensors and to enable communication between the sensors and the controller of the HVAC system. Manufacturing of the HVAC system may therefore be simplified and accelerated by avoiding installation of such low-voltage wires/low-voltage wiring harnesses. Furthermore, by reducing or eliminating the number of low-voltage wires in the HVAC system, the HVAC system may be more robust and resilient. In particular, the HVAC system may be less susceptible to interference from environmental conditions, such as adverse weather. For example, wired connection points that typically couple a power and/or communication wire to the controller and to the sensor are reduced or eliminated, thereby reducing or eliminating power or communication distribution interference attributable to malfunction of the connection points.

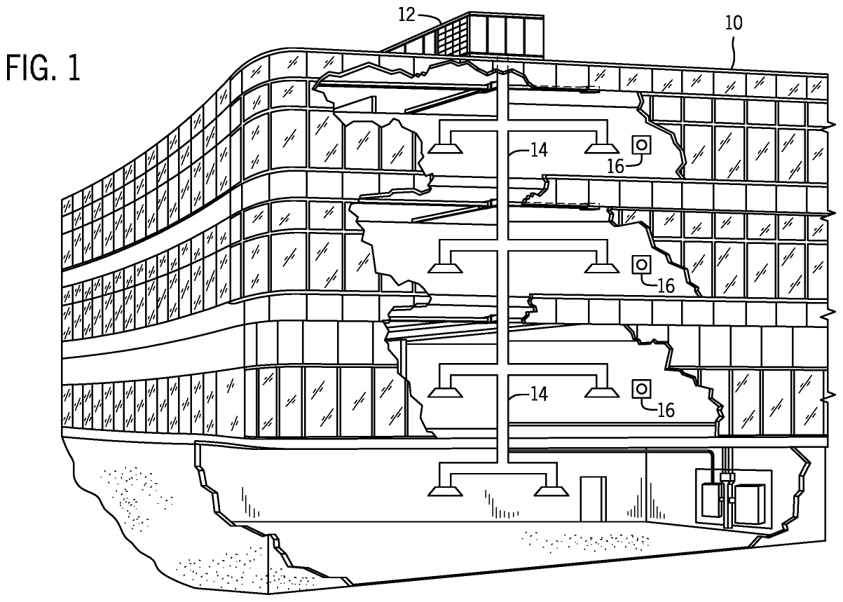

Turning now to the drawings, FIG. 1 illustrates an embodiment of a heating, ventilation, and/or air conditioning (HVAC) system for environmental management that may employ one or more HVAC units. As used herein, an HVAC system includes any number of components configured to enable regulation of parameters related to climate characteristics, such as temperature, humidity, air flow, pressure, air quality, and so forth. For example, an “HVAC system” as used herein is defined as conventionally understood and as further described herein. Components or parts of an “HVAC system” may include, but are not limited to, all, some of, or individual parts such as a heat exchanger, a heater, an air flow control device, such as a fan, a sensor configured to detect a climate characteristic or operating parameter, a filter, a control device configured to regulate operation of an HVAC system component, a component configured to enable regulation of climate characteristics, or a combination thereof. An “HVAC system” is a system configured to provide such functions as heating, cooling, ventilation, dehumidification, pressurization, refrigeration, filtration, or any combination thereof. The embodiments described herein may be utilized in a variety of applications to control climate characteristics, such as residential, commercial, industrial, transportation, or other applications where climate control is desired.

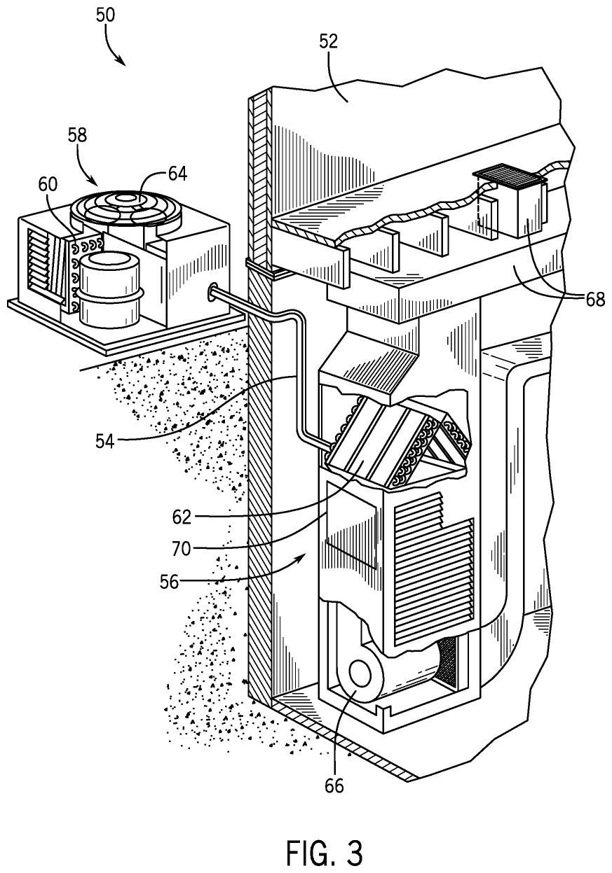

In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

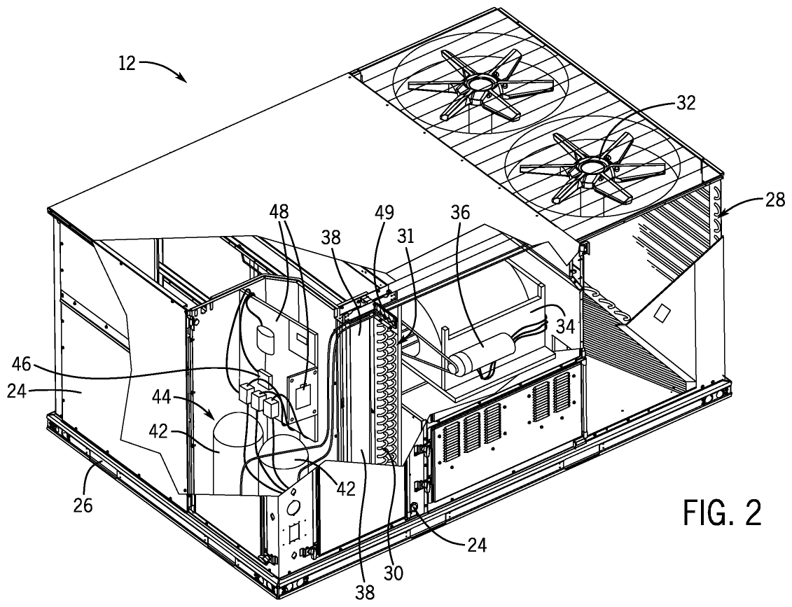

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant, such as R-410A, through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms. One or more of these components may be referred to herein separately or collectively as the control device 16. The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant, which may be expanded by an expansion device, and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat, or a set point plus a small amount, the residential heating and cooling system 50 may become operative to refrigerate additional air for circulation through the residence 52. When the temperature reaches the set point, or a set point minus a small amount, the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger, separate from heat exchanger 62, such that air directed by the blower 66 passes over the tubes or pipes and extracts heat from the combustion products. The heated air may then be routed from the furnace system 70 to the ductwork 68 for heating the residence 52.

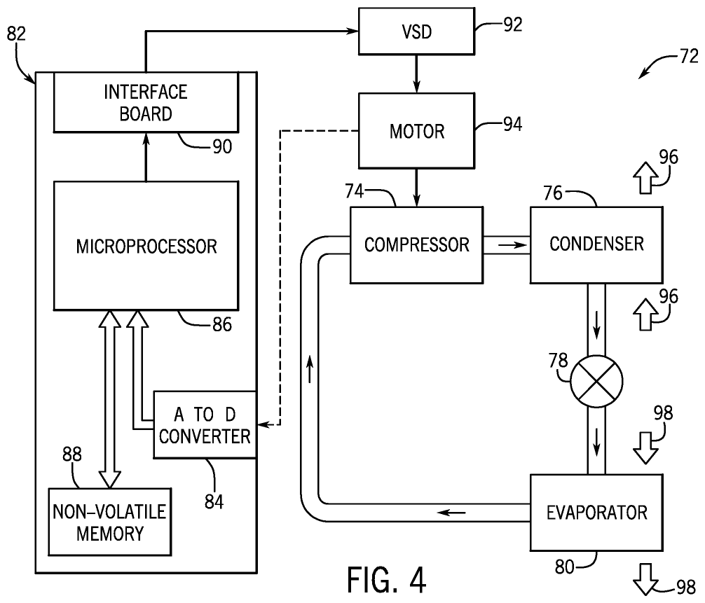

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

As discussed above, embodiments of the present disclosure are directed to a wireless system that enables wireless communication between sensors and a controller of an HVAC system. By incorporating a wireless system, the HVAC system may be manufactured without low-voltage wires/low-voltage wiring harnesses, which may accelerate and simplify the manufacturing process. Reducing or eliminating the number of low-voltage wires/low-voltage wiring harnesses in the HVAC system may also improve the robustness of the HVAC system. For example, the wireless system may be more weather resistant than traditional wired sensor systems.

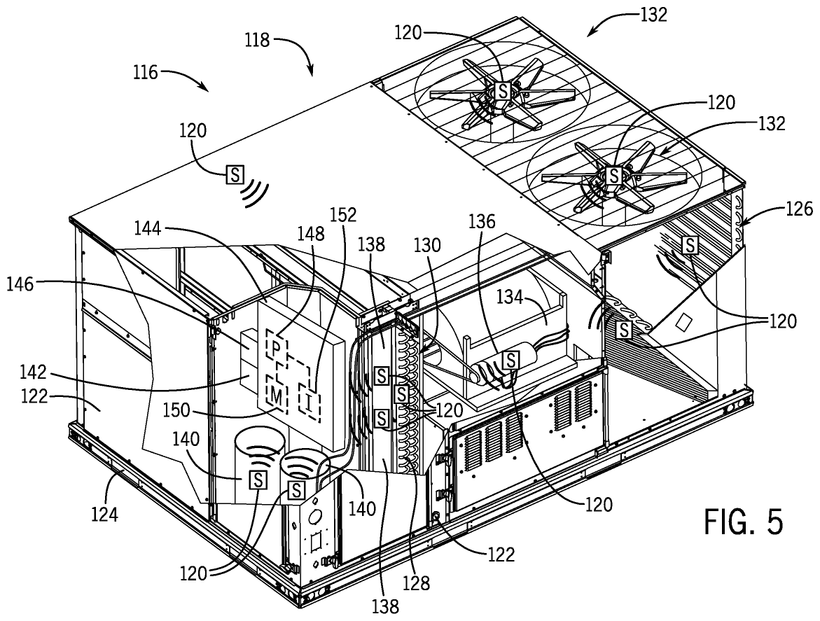

FIG. 5 is a perspective view of an embodiment of an HVAC unit 116 with a wireless system 118. As will be explained below, the wireless system 118 includes one or more wireless sensors 120 that enable wireless communication within the HVAC unit 116. In some embodiments, the HVAC unit 116 is a single packaged unit that may include one or more independent refrigeration circuits and components. The HVAC unit 116 may provide a variety of heating and/or cooling functions, such as cooling only, heating only, cooling with electric heat, cooling with dehumidification, cooling with gas heat, cooling with a heat pump, or heating with a furnace. The HVAC unit 116 may directly cool and/or heat an air stream provided to the building 10 to condition a space in a building. It should be understood that the disclosed wireless system 118 may be used with other HVAC systems, such as the residential heating and cooling system 50 described above with reference to FIG. 3.

A cabinet or housing 122 encloses the HVAC unit 116 and provides structural support and protection to internal components from external elements, such as rain, snow, and wind. In some embodiments, the housing 122 may be constructed of galvanized steel and may be insulated with aluminum foil faced insulation. Rails 124 may be joined to the bottom perimeter of the housing 122 to provide a foundation for the HVAC unit 116. In some embodiments, the rails 124 may fit into or around “curbs” on a building rooftop to enable the HVAC unit 116 to provide air to ductwork of the building from the bottom of the HVAC unit 116 while blocking elements such as rain from leaking into the building.

The HVAC unit 116 includes heat exchangers 126 and 128 in fluid communication with one or more refrigerant circuits. Tubes within the heat exchangers 126 and 128 may circulate refrigerant through the heat exchangers 126 and 128. The heat exchangers 126 and 128 enable a thermal cycle in which the refrigerant undergoes phase changes and/or temperature changes as it flows through the heat exchangers 126 and 128 to produce heated and/or cooled air. For example, the heat exchanger 126 may function as a condenser where heat is released from the refrigerant to ambient air, and the heat exchanger 128 may function as an evaporator where the refrigerant absorbs heat to cool an air stream. In some embodiments, the HVAC unit 116 may operate in a heat pump mode where the roles of the heat exchangers 126 and 128 may be reversed. That is, the heat exchanger 126 may function as an evaporator, and the heat exchanger 128 may function as a condenser. In further embodiments, the HVAC unit 116 may include a furnace for heating the air stream that is supplied to the building. While the illustrated embodiment of FIG. 5 shows the HVAC unit 116 having two of the heat exchangers 126 and 128, in other embodiments, the HVAC unit 116 may include one heat exchanger or more than two heat exchangers.

The heat exchanger 128 is located within a compartment 130 that separates the heat exchanger 128 from the heat exchanger 126. Fans 132 draw air from the environment across the heat exchanger 126. Air may be heated and/or cooled as the air flows across the heat exchanger 126 before being released back to the environment surrounding the HVAC unit 116. A blower assembly 134, powered by a motor 136, draws air across the heat exchanger 128 to heat or cool the air. The heated or cooled air may be directed to the building by the ductwork, which may be connected to the HVAC unit 116. Before flowing across the heat exchanger 128, the conditioned air flows through one or more filters 138 that may remove particulates and contaminants from the air. In certain embodiments, the filters 138 may be disposed on the air intake side of the heat exchanger 128 to prevent contaminants from contacting the heat exchanger 128.

The HVAC unit 116 may also include other equipment for implementing the thermal cycle. Compressors 140 increase the pressure and temperature of the refrigerant before the refrigerant enters the heat exchanger 126. The HVAC unit 116 may receive power through a terminal block 142. For example, a high voltage power source may be connected to the terminal block 142 to power the equipment, such as the compressors 140, fans 132, motor 136, a controller 144, dampers, and valves. In some embodiments, the controller 144 receives power from a transformer 146 coupled to the terminal block 142.

The HVAC unit 116 includes the controller 144 to monitor and/or control the HVAC system 116. The controller 144 includes a processor 148 and a memory 150. For example, the processor 148 may be a microprocessor that executes software to control the HVAC system 116. The processor 148 may include multiple microprocessors, one or more “general-purpose” microprocessors, one or more special-purpose microprocessors, and/or one or more application specific integrated circuits (ASICS), or some combination thereof. For example, the processor 148 may include one or more reduced instruction set (RISC) processors.

The memory 150 may include a volatile memory, such as random access memory (RAM), and/or a nonvolatile memory, such as read-only memory (ROM). The memory 150 may store a variety of information and may be used for various purposes. For example, the memory 150 may store processor executable instructions, such as firmware or software, for the processor 148 to execute. The memory 150 may include ROM, flash memory, a hard drive, or any other suitable optical, magnetic, or solid-state storage medium, or a combination thereof. The memory 150 may store data, instructions, and any other suitable data.

In order for the sensors 120 to communicate with the controller 144, the controller 144 includes a wireless interface 152. The wireless interface 152 may be any device, such as interface circuitry, configured to enable wireless communications with the controller 144. In operation, the controller 144 may receive equipment data from the HVAC unit 116 using sensors 120. These sensors 120 may be any type of sensor used in HVAC systems, such as air or refrigerant temperature sensors, humidity sensors, air pressure sensors, refrigerant pressure sensors, flow rate sensors, carbon dioxide sensors, air quality sensors, freeze stat sensors, compressor speed sensors, smoke detection sensors, rotation sensors (RPM sensors), and so forth. The data from these sensors 120 is communicated to the controller 144 wirelessly using suitable wireless communication protocol, such as 802.11a/b/g/n/ac, Bluetooth, RFID, any suitable frequency band, such as 2.4 GHz, 5 GHz, or 5.8 GHz, or any other wireless communication protocol. As the controller 144 receives data from the sensors 120, the controller 144 processes the data with the processor 148 and then controls operation of the HVAC system 116 in response to the data.

By including sensors 120 configured to communicate wirelessly with the controller 144, the HVAC system 116 may be manufactured without low-voltage wires/low-voltage wiring harnesses. As explained above, low-voltage wires typically couple sensors to the controller 144 to enable communication therebetween and to provide power to the sensors. By excluding these wires, the manufacture of the HVAC system 116 may be simplified and accelerated. Furthermore, by reducing or eliminating the number of low-voltage wires/low-voltage wiring harnesses in the HVAC system 116, the HVAC system 116 may be more robust and resilient. For example, the HVAC system 116 may be more weather resistant. That is, the HVAC system 116 reduces or eliminates weather-susceptible wired connection points that typically couple a power/communication wire to the controller 144 and to the sensors. In addition, because the controller 144 may not provide power to the sensors 120 of present embodiments, the HVAC system 116 may include a smaller transformer 146, which may reduce the cost of the overall HVAC system 116.

In some embodiments, the controller 144 may communicate with an external wired or wireless network. For example, the controller 144 may communicate with external network devices, such as devices other than the sensors 120 of the HVAC system 116. In some embodiments, the controller 144 may communicate with a building management system that enables an operator to monitor and control operation of the HVAC system 116.

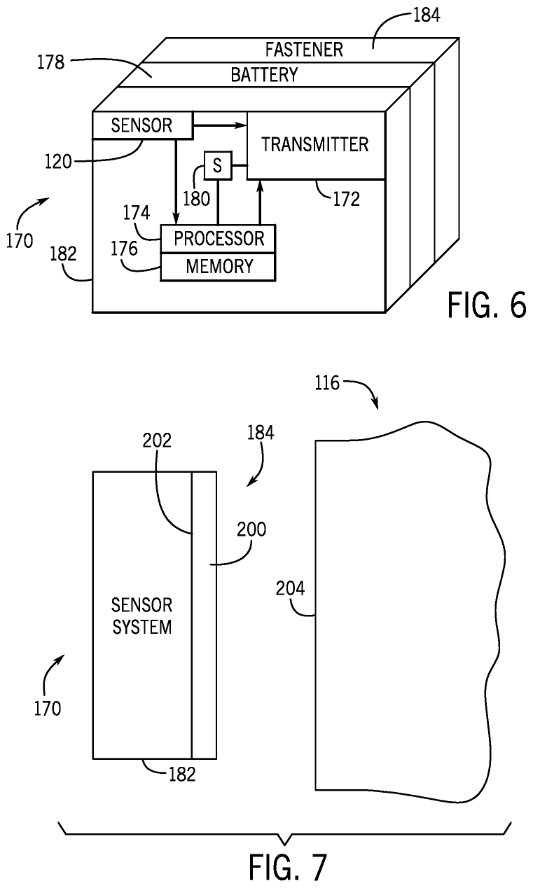

FIG. 6 is a perspective view schematic of an embodiment of a sensor system 170. The sensor system 170 includes the sensor 120 that detects an operating condition of the HVAC system 116. As explained above, the sensors 120 may detect air or refrigerant temperature, humidity, air pressure, refrigerant pressure, flow rates, carbon dioxide, air quality, compressor speeds, smoke, or other operating parameter of the HVAC system 116. In order to transmit the detected operating condition or other data, the sensor system 170 includes a transmitter 172. The transmitter 172 is a wireless transmitter that enables the sensor system 170 to wirelessly communicate with the controller 144. By communicating wirelessly with the sensors 120, the HVAC system 116 may reduce or eliminate the number of or low-voltage wires that provide power to and enable communication with the sensors 120.

In some embodiments, the sensor system 170 may include a processor 174 and a memory 176. In operation, the processor 174 may process data from the sensor 120 for storage in the memory 176, as well as for transmission by the transmitter 172. For example, the processor 174 may convert the data into a desired format for wireless transmission. In some embodiments, the processor 174 and memory 176 may process the data in order to maintain a log or record of the monitored operating condition. In some embodiments, the processor 174 and memory 176 may enable storage of data for later transmission. For example, if communication between the sensor system 170 and the controller 144 is interrupted, the processor 174 and memory 176 may determine when communication was lost and may store the monitored operating condition data until communication is restored. Once communication is reestablished, the processor 174 may send the transmitted data to the transmitter 172 for wireless transmission to the controller 144.

The sensor system 170 powers the sensor 120, transmitter 172, processor 174, and memory 176 with a battery or batteries 178. The batteries 178 enable the sensor 120 and sensor system 170 to operate without coupling to a remote power source, such as the controller 144. By removing low-voltage power wires, manufacturing of the HVAC system 116 may be improved, and weather resistance of the HVAC system 116 may be improved. Specifically, without the low-voltage power wires, the number of electrical hardwired connection points of the HVAC system 116 that may be exposed to weather, such as rain, snow, and wind, or other adverse conditions is reduced. In some embodiments, the battery 178 may be a single use battery. The battery 178 may therefore be removed and replaced once drained. In some embodiments, the battery 178 may be a rechargeable battery capable of being recharged after prolonged use.

The sensor system 170 may detect the charge of the battery 178. For example, the sensor system 170 may include a battery sensor 180 that detects the charge of the battery 178. The detected battery 178 charge may then be transmitted to the controller 144, thereby enabling an operator to monitor operation of and perform timely maintenance of the sensor system 170.

The components of the sensor system 170, such as the sensor 120, battery sensor 180, transmitter 172, processor 174, and memory 176 may be contained within or coupled to a housing 182. For example, the housing 182 may be a weather resistant housing capable of protecting the components therein from rain, snow, other moisture, and wind. During manufacturing of the HVAC system 116, the sensor system 170 may be installed by coupling the housing 182 to the housing 122 and/or to an HVAC component of the HVAC unit 116. These HVAC components may include the heat exchangers 126, 128, the fans 132, motor 136, filters 138, ductwork, blower 134, and compressors 140, among others. To facilitate installation/attachment, the sensor system 170 may include a coupling system 184. In some embodiments, the coupling system 184 may include one or more magnets coupled to or disposed within the housing 182. In some embodiments, the coupling system 184 may include an adhesive coupled to the housing 182 that facilitates attachment of the sensor system 170 to the HVAC system 116. In still other embodiments, the coupling system 184 may include one or more threaded fasteners that couple the housing 182 to the HVAC system 116. Indeed, the coupling system 184 may include any suitable fastening mechanism or feature configured to enable attachment of the sensor system to another surface or component.

FIG. 7 is a side view schematic of the sensor system 170 coupling to the HVAC system 116. As explained above, the sensor system 170 includes the coupling system 184 to facilitate attachment of the sensor system 170 to the HVAC system 116. As used herein, the HVAC system 116 should be understood to include the housing 122 and/or any component of the HVAC system 116. In some embodiments, the coupling system 184 may include an adhesive 200, such as an adhesive strip. The adhesive 200 may couple to a surface 202 of the housing 182, thereby enabling attachment of the housing 182 to a surface 204 of the HVAC system 116. In some embodiments, the adhesive 200 may be first coupled to the surface 204 of the HVAC system 116 after which the housing 182 is coupled to the adhesive 200. The adhesive 200 may be a drying adhesive, pressure-sensitive adhesive, contact adhesive, hot adhesive, multi-part adhesive, one-part adhesive, among others.

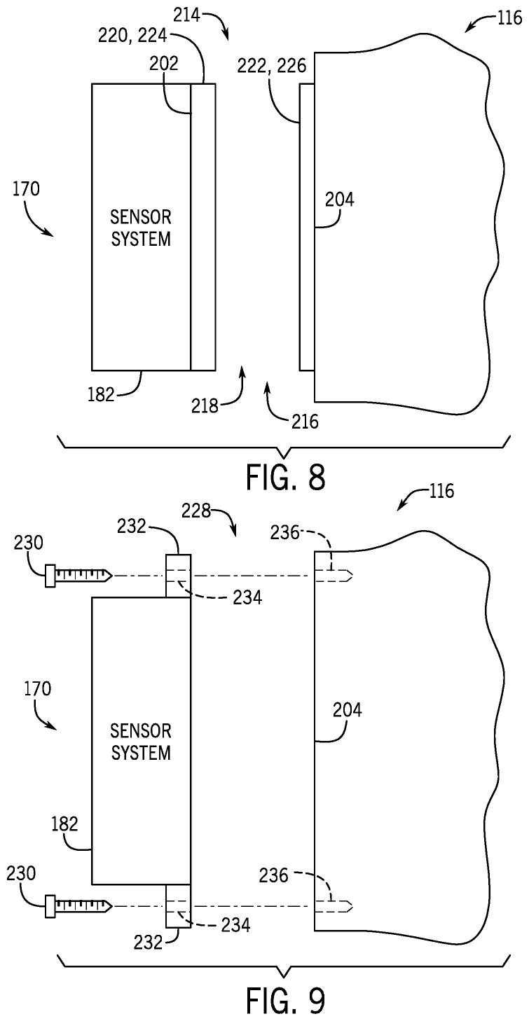

FIG. 8 is a side view of the sensor system 170 coupling to the HVAC system 116 with a coupling system 214. In some embodiments, the coupling system 214 may include one or more magnets 216 or hook and loop fasteners 218. For example, a first magnet(s) 220 may couple to the surface 202 of the housing 182 or may be placed within the housing 182. The first magnet(s) 220 may enable the sensor system 170 to couple directly to the surface 204 of the HVAC system 116, such as a metallic surface of the HVAC system 116. In some embodiments, a second magnet 222 may be coupled to the surface 204 with adhesives. The first magnet 220 may then couple to the second magnet 222 to hold the sensor system 170 in a desired location. In embodiments where the coupling system 214 is the hook and loop fastener 218, a hook pad 224 may couple to the housing 182, and a loop pad 226 may couple to the surface 204. When pressed together the hook pad 224 and loop pad 226 fasten together to couple the sensor system 170 to the HVAC system 116. It should be understood that the arrangement of the hook and loop pads 224, 226 may be reversed with the loop pad 226 coupling to the sensor system 170 and the hook pad 224 coupling to the HVAC system 116.

FIG. 9 is a side view schematic of the sensor system 170 coupling to the HVAC system 116 with a coupling system 228. In some embodiments, the coupling system 228 may include one or more fasteners 230 that extend through a portion of the housing 182 to couple the sensor system 170 to the HVAC system 116. For example, the housing 182 may include one or more flanges 232 that define apertures 234. These apertures 234 may be aligned with apertures 236 in the surface 204 of the HVAC system 116. The sensor system 170 couples to the HVAC system 116 by extending the fasteners 230 through the apertures 234 in the housing 182 and into the apertures 236 in the HVAC system 116. The fasteners 230 may be threaded fasteners, snap-fit fasteners, among others.

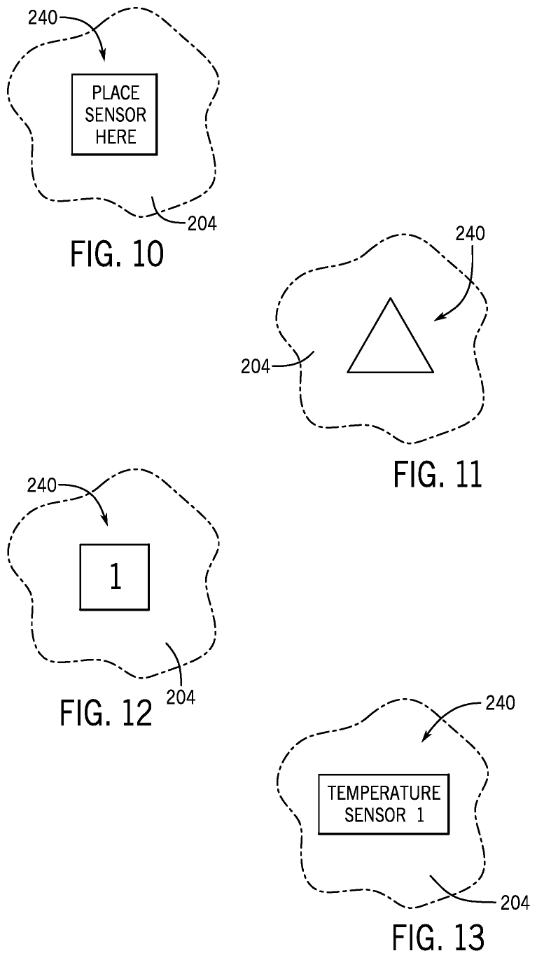

FIGS. 10-13 are front views of embodiments of the surface 204 of the HVAC system 116 with markings 240. These markings 240 may be placed on components of the HVAC system 116 and/or on the housing 122 to facilitate placement of the sensors 120 and/or sensor systems 170, such as during installation, replacement, or maintenance. Placement of the sensors 120 and/or sensor systems 170 in particular locations on the HVAC system 116 may facilitate communication and accurate monitoring of operational conditions of the HVAC system 116. Accordingly, to facilitate proper placement on the HVAC system 116, one or more surfaces 204 of the HVAC system 116 may include markings 240 that indicate where the sensor 120 and/or sensor system 170 should be placed. The markings 240 may include letters, numbers, symbols, colors, and combinations thereof. In some embodiments, these markings 240 may be engraved into the surface 204. In some embodiments, the markings 240 may be on stickers that are then attached to the surface 204 of the HVAC system 116.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A heating, ventilation, and/or air conditioning (HVAC) system, comprising:
an HVAC housing configured to house a heat exchanger;
a sensor configured to detect an operating condition of the HVAC system and configured to wirelessly transmit a signal indicative of the operating condition, wherein the sensor is coupled to or disposed within the HVAC housing; and
a controller configured to receive the signal indicative of the operating condition and configured to control operation of the HVAC system in response to the signal, wherein the controller is coupled to or disposed within the HVAC housing.

2. The HVAC system of claim 1, wherein the sensor is a temperature sensor, a humidity sensor, an air pressure sensor, a refrigerant pressure sensor, a flow rate sensor, a carbon dioxide sensor, an air quality sensor, a freeze stat sensor, a compressor speed sensor, a smoke detection sensor, or a combination thereof.

3. The HVAC system of claim 1, comprising a transformer configured to power the controller.

4. The HVAC system of claim 3, wherein the transformer is rated at less than 50 VA.

5. The HVAC system of claim 1, wherein the HVAC system excludes a wire extending between the controller and the sensor.

6. The HVAC system of claim 1, wherein the HVAC housing and/or HVAC equipment coupled to or disposed within the HVAC housing has a marking configured to mark a location for placement of the sensor.

7. The HVAC system of claim 1, wherein the sensor has a battery configured to power the sensor.

8. The HVAC system of claim 1, wherein the sensor has a fastener configured to mount the sensor to HVAC equipment or the HVAC housing.

9. The HVAC system of claim 8, wherein the fastener is a magnet or an adhesive.

10. The HVAC system of claim 8, wherein the fastener is a hook and loop fastener.

11. A heating, ventilation, and/or air conditioning (HVAC) system, comprising:
an HVAC housing configured to house a heat exchanger;
a sensor system configured to detect an operating condition of the HVAC system and configured to wirelessly transmit a signal indicative of the operating condition, wherein the sensor system is coupled to or disposed within the HVAC housing, and the sensor system comprises:
a sensor configured to detect the operating condition of the HVAC system; and
a power source configured to power the sensor and wireless transmission of the signal indicative of the operating condition.

12. The HVAC system of claim 11, comprising a controller configured to receive the signal indicative of the operating condition and configured to control operation of the HVAC system in response to the signal, wherein the controller is coupled to or disposed within the HVAC housing.

13. The HVAC system of claim 11, wherein the sensor is a temperature sensor, a humidity sensor, an air pressure sensor, a refrigerant pressure sensor, a flow rate sensor, a carbon dioxide sensor, an air quality sensor, a freeze stat sensor, a compressor speed sensor, a smoke detection sensor, or a combination thereof.

14. The HVAC system of claim 11, wherein the sensor system comprises a fastener configured to mount the sensor to HVAC equipment or the HVAC housing.

15. The HVAC system of claim 14, wherein the fastener comprises a magnet.

16. The HVAC system of claim 14, wherein the fastener comprises a hook and loop fastener.

17. The HVAC system of claim 11, wherein the power source is a battery.

18. A heating, ventilation, and/or air conditioning (HVAC) system, comprising:
an HVAC housing configured to house a heat exchanger, wherein the HVAC housing or HVAC equipment coupled to or disposed within the HVAC housing comprises a marking disposed thereon; and
a sensor configured to detect an operating condition of the HVAC system and configured to wirelessly transmit a signal indicative of the operating condition, wherein the sensor is coupled to or disposed within the HVAC housing proximate the marking to facilitate desired operation of the sensor.

19. The HVAC system of claim 18, wherein the marking is disposed on the HVAC equipment to facilitate placement of the sensor for desired operation of the sensor.

20. The HVAC system of claim 18, wherein the marking is an engraving.

21. The HVAC system of claim 18, wherein the marking has letters, numbers, colors, symbols or a combination thereof.

22. The HVAC system of claim 18, wherein the sensor is a temperature sensor, a humidity sensor, an air pressure sensor, a refrigerant pressure sensor, a flow rate sensor, a carbon dioxide sensor, an air quality sensor, a freeze stat sensor, a compressor speed sensor, a smoke detection sensor, or a combination thereof.

23. The HVAC system of claim 18, wherein the marking is positioned on the HVAC equipment to substantially optimize operation of the sensor when installed proximate the marking.
